(19) United States
(12) Patent Application Publication
(10) Pub. No.: US 2026/0031413 A1
(43) Pub. Date: Jan. 29, 2026

(54) ANODE-FREE LITHIUM BATTERY

(71) Applicant: GM GLOBAL TECHNOLOGY OPERATIONS LLC, Detroit, MI (US)

(72) Inventors: Yun-Yu Lai, Clawson, MI (US); Yifan Zhao, Troy, MI (US); Thomas A. Yersak, Royal Oak, MI (US)

(73) Assignee: GM GLOBAL TECHNOLOGY OPERATIONS LLC, Detroit, MI (US)

(21) Appl. No.: 18/784,772

(22) Filed: Jul. 25, 2024

(51) Int. Cl. H01M 10/42; B60L 50/64; H01M 4/02; H01M 4/136; H01M 4/58; H01M 10/0525; H01M 10/056

(52) U.S. Cl. CPC H01M 10/4235; B60L 50/64; H01M 4/136; H01M 4/5815; H01M 10/0525; H01M 10/056; H01M 2004/028; H01M 2220/20; H01M 2300/0025; H01M 2300/0071

(57) ABSTRACT

Battery cells, vehicles with battery cells, and methods for forming battery cells are provided. A battery cell includes a cathode electrode comprising a cathode active material, wherein the cathode active material comprises lithium sulfide (Li₂S); an anode current collector serving as an anode electrode; a solvate ionic liquid (SIL) electrolyte; and a fluorinated ether diluent.

### INTRODUCTION

The disclosure relates to motor vehicle battery systems, and more specifically to rechargeable lithium batteries.

Secondary, or rechargeable, lithium ion batteries are often used in many stationary and portable devices, such as those encountered in the consumer electronic, automobile, and aerospace industries. The lithium class of batteries has gained popularity for various reasons, including a relatively high energy density, a general nonappearance of any memory effect when compared to other kinds of rechargeable batteries, a relatively low internal resistance, and a low self-discharge rate when not in use. The ability of lithium batteries to undergo repeated power cycling over their useful lifetimes makes them an attractive and dependable power source.

Lithium ion batteries exhibit benefits including light weight structure, relatively high energy density, and good cycle life. Nevertheless, for high power applications such as electrical vehicles (EVs) and hybrid electrical vehicles (HEVs), lithium ion batteries may benefit from an increase in energy density.

Accordingly, there is a need for lithium ion batteries having increased cell energy density while maintaining safety and reducing manufacturing costs. Furthermore, other desirable features and characteristics of the present disclosure will become apparent from the subsequent detailed description and the appended claims, taken in conjunction with the accompanying drawings and the foregoing introduction.

### SUMMARY

In an embodiment, a battery cell is provided and includes a cathode electrode including a cathode active material, wherein the cathode active material includes lithium sulfide (Li₂S); an anode current collector serving as an anode electrode; a solvate ionic liquid (SIL) electrolyte; and a fluorinated ether diluent.

In certain embodiments, the battery cell further includes a solid-electrolyte interphase (SEI) layer comprised of Li₂S and Li₂S₂.

In certain embodiments, the battery cell further includes a lithium plating layer formed over the anode current collector; and a solid-electrolyte interphase (SEI) layer formed over the lithium plating layer, and the SEI layer is comprised of reduced polysulfides including Li₂S and Li₂S₂.

In certain embodiments of the battery cell, the cathode active material includes a composite of lithium sulfide (Li₂S) and carbon.

In certain embodiments of the battery cell, the cathode active material further includes a transition metal sulfide.

In certain embodiments of the battery cell, the cathode electrode includes from about fifty (50) to about ninety (90) weight percent of the cathode active material, based on a total weight of the cathode electrode.

In certain embodiments of the battery cell, the cathode electrode further includes a solid state electrolyte (SSE), the solid state electrolyte is a sulfidic solid state electrolyte selected from: yLi₂S·(100−y−x)P₂S₅·xP₂O₅, wherein y is from 70 to 80 mol % and x is from 1 to 10 mol %; Li₁₀MP₂S₁₂, wherein M is Si, Ge, or Sn; and electrolytes of the formula A₁₂₋ₘ₋ₓ⁺(M^{m+}Y₄²⁻)Y₂₋ₓ²⁻Xₓ⁻ wherein A⁺=Li⁺, Cu⁺, Ag⁺; M^{m+}=Si⁴⁺, Ge⁴⁺, Sn⁴⁺, P⁵⁺, As⁵⁺; Y²⁻=O²⁻, S²⁻, Se²⁻, Te²⁻; X⁻=Cl⁻, Br⁻, I⁻; and 0≤x≤2; and the cathode electrode includes up to thirty (30) weight percent of the solid state electrolyte.

In certain embodiments of the battery cell, the cathode electrode further includes a binder selected from styrene-butadiene rubber (SBR), hydrogenated nitrile butadiene rubber (HNBR), polyvinylidene difluoride (PVDF), poly(vinylidene fluoride-co-hexafluoropropylene) (PVDF-HFP), poly(ethylene oxide) (PEO), polytetrafluoroethylene (PTFE), and poly(tetrafluoroethylene-co-perfluoro(3-oxa-4-pentenesulfonic acid)) lithium salt, and the cathode electrode includes five (5) to ten (10) weight percent of the binder, based on a total weight of the cathode electrode.

In certain embodiments of the battery cell, the cathode electrode further includes conductive carbon, the conductive carbon is selected from carbon black, carbon nanotubes, graphene, and/or acetylene black, and the cathode electrode comprises up to five (5) weight percent of the conductive carbon, based on a total weight of the cathode electrode.

In certain embodiments, the battery cell further includes a separator including a polypropylene (PP), polyethylene (PE), or polypropylene/polyethylene (PE/PP) porous membrane.

In certain embodiments of the battery cell, the SIL electrolyte is selected from Li[G2]TFSI, Li[G2]TFSI, Li[G3]TFSI, Li[G4]TFSI, Li[G3]FSI, Li[G4]FSI, Li[G3]BETI, Li[G4]BETI, Li[G3]CTFSI, Li[G4]CTFSI, Li[G3]C104, Li[G4]C104, Li[G3]BF₄, and Li[G4]BF₄.

In certain embodiments of the battery cell, the fluorinated ether diluent is selected from 1,1,2,2 tetrafluoroethyl-2,2,3,3-tetrafluoropropyl ether (TTE), Ethyl 1,1,2,2-tetrafluoroethyl ether (ETE), Hexafluoroisopropyl methyl ether (HFME), 1,1,2,2-Tetrafluoroethyl 2,2,2-Trifluoroethyl Ether, Ethyl 1,1,2,3,3,3-Hexafluoropropyl Ether, Methyl Nonafluorobutyl Ether (mixture of isomers), Difluoromethyl 2,2,3,3-Tetrafluoropropyl Ether, Bis(2,2,2-trifluoroethyl) ether (BTFE), 1H,1H,5H-Octafluoropentyl 1,1,2,2-Tetrafluoroethyl Ether (OTE), 1,1,2,3,3,3 hexafluoropropyl-2,2,2-trifluoroethyl ether, 1,1,1,2,2,3,4,5,5,5-Decafluoro-3-methoxy-4-(trifluoromethyl)pentane, Fluoromethyl 1,1,1,3,3,3-Hexafluoroisopropyl Ether, 1,1,2,3,3,3-Hexafluoropropyl Methyl Ether, Hexafluoroisopropyl Methyl Ether, Methyl 2,2,3,3,3-Pentafluoropropyl Ether, and Methyl 1,1,2,2-Tetrafluoroethyl Ether.

In certain embodiments of the battery cell, the SIL electrolyte and the fluorinated ether diluent are present in a SIL/diluent weight ratio of from 1:0.5 to 1:5 weight ratio.

In certain embodiments of the battery cell, the electrolyte loading is from 1 to about 10 g/Ah.

In certain embodiments of the battery cell, the current collector is copper foil, carbon-coated copper, copper mesh, polyethylene terephthalate (PET) supported copper foil, or a combination thereof.

In another embodiment, a vehicle is provided and includes a rechargeable energy storage system (RESS) including battery cells, each battery cell includes: a cathode electrode; an anode current collector acting as an anode electrode; a separator; a lithium plating layer formed over the current collector; and a solid-electrolyte interphase (SEI) layer formed over the lithium plating layer, and the SEI layer is comprised of reduced polysulfides including Li₂S and Li₂S₂.

In certain embodiments of the vehicle, each battery cell further includes and/or wherein the separator includes: a solvate ionic liquid (SIL) electrolyte; and a fluorinated ether diluent.

In certain embodiments of the vehicle, in each battery cell: the cathode electrode includes a cathode active material, a solid electrolyte, and a binder; the cathode active material includes lithium sulfide (Li₂S) and a transition metal sulfide; and the cathode electrode includes from about fifty (50) to about ninety (90) weight percent of the cathode active material, based on a total weight of the cathode electrode.

Another embodiment provides a method for forming a battery cell. The method includes interconnecting a cathode current collector and an anode current collector to form a circuit, wherein the cathode current collector contacts a cathode active material including lithium sulfide (Li₂S); and performing an activation process including: electroplating lithium ions from the cathode active material onto the anode current collector to form a layer of anode active material; and forming a solid electrolyte interphase (SEI) layer over the layer of anode active material, wherein the SEI layer is formed from polysulfide.

In certain embodiments of the method, the cathode active material including lithium sulfide (Li₂S) and the anode current collector are in contact with a solvate ionic liquid (SIL) electrolyte diluted in a fluorinated ether diluent, and wherein the method further includes extracting the lithium ions from the cathode active material with the SIL electrolyte diluted in the fluorinated ether diluent.

### DESCRIPTION OF THE DRAWINGS

The present disclosure will hereinafter be described in conjunction with the following drawing figures, wherein like numerals denote like elements, and wherein:

FIG. 1 schematically illustrates a vehicle provided with a secondary battery cell in accordance with embodiments herein;

FIGS. 2 and 3 schematically illustrate the battery cell of FIG. 1, in accordance with embodiments herein; and

FIG. 4 schematically illustrates a process for fabricating a battery cell described with reference to FIGS. 2 and 3, in accordance with embodiments herein.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, summary or the following detailed description.

Embodiments of the present disclosure may be described herein in terms of functional and/or logical block components and various processing steps. Connecting lines shown in the various figures contained herein are intended to represent example functional relationships and/or physical couplings between the various elements. It should be noted that many alternative or additional functional relationships or physical connections may be present in an embodiment of the present disclosure.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

An electrochemical cell, i.e., a battery cell, includes an anode and a cathode, an electrolyte, and a separator that are assembled in a container. Electrochemical cells can be electrically connected in a stack to increase overall output, such as in a lithium-ion battery pack.

Lithium-ion electrochemical cells operate by reversibly passing lithium ions between the anode and the cathode, with the separator and an electrolyte disposed therebetween. The electrolyte is employed to conduct lithium ions and may be in liquid, gel, or solid form. Lithium ions move from the cathode to the anode during charging of the battery, and in the opposite direction when discharging the battery.

The anode and cathode are each electrically connected to a current collector, which may be a metal, such as copper for the anode and aluminum for the cathode. During battery usage, the current collectors associated with the anode and the cathode are connected by an external circuit that allows current generated by electrons to pass between the negative and positive electrodes to compensate for transport of lithium ions.

Electrodes can be incorporated into various commercial battery designs, such as prismatic shaped cells, wound cylindrical cells, coin cells, pouch cells, or other suitable cell shapes. The cells can include a single electrode structure of each polarity or a stacked structure with a plurality of positive electrodes and negative electrodes assembled in parallel and/or series electrical connections. In particular, the battery can include a stack of alternating anodes and cathodes with separators disposed therebetween.

Lithium ion batteries may have various components comprising an anode current collector, an anode material, an electrolyte, a separator, a cathode material, a cathode current collector and a housing. An anode of a lithium-ion battery may be formed by applying an electro-active material onto an anode current collector to produce an active material layer which may comprise an active material, conducting material, and a binder.

Embodiments herein reduce the size of a lithium ion battery cell by eliminating the anode to form an anode-less or anode-free battery cell. As used herein, “anode-free”, and “anode-less” refer to battery geometries fabricated in a discharged state with only a current collector as the negative electrode, i.e., anode. Such geometries may achieve both low N/P ratios (e.g., about 0 to 1) and energy densities that are significantly greater than that of conventional lithium ion batteries.

Embodiments of anode-free semi solid-state battery cells described herein may be formed with bare copper as a current collector and anode. With this design, no additional anode electrode (graphite or silicon) is used.

Embodiments herein provide a battery architecture including a lithiated cathode, a separator or solid-state electrolyte and ionic liquid, and a current collector.

In certain embodiments, active anode material forms during the first charge cycle as lithium ions from the cathode travel through the electrolyte and are plated onto the current collector. More specifically, lithium ions extracted from the cathode are electroplated onto the surface of the anode current collector, forming a deposited lithium together with an electrochemically stable solid electrolyte interphase (SEI) during the charging process. The deposited lithium is the only available lithium source for discharge. From this reason, the safety hazard often posed in the lithium metal battery is greatly reduced because there is no active lithium source at the anode side. During discharge (e.g., electro-dissolution), ions are stripped from the anode, travel through the electrolyte and react with the cathode.

In embodiments herein, the solid electrolyte interphase (SEI) layer is formed over the plated lithium layer. The SEI layer is an electrically insulating and ionically conductive passivation layer that serves as a protection layer for the freshly plated lithium layer and may extend the cycle life of the lithium ion battery.

In embodiments herein, the combination of slightly dissolved lithium polysulfides in the SIL/diluent electrolyte provides for forming the ion-conducting SEI layer on the lithium metal anode active material. In certain embodiments, the lithium polysulfides include compounds of Li₂Sₓ, where x is from 2 to 8. In certain embodiments, the lithium polysulfides include compounds of Li₂Sₓ, where x is 1, 2, 4, and 6.

The lithium metal SEI layer may include lithium sulfide (Li₂S) and/or lithium disulfide (Li₂S₂) formed from reduced polysulfides. The lithium metal SEI layer may contain several other compounds from different sources. For example, the lithium metal SEI layer may include inorganic compounds from the reduction of liquid electrolyte salt (LiTFSI) and solvents (e.g., G4 and TTE). Further, the lithium metal SEI layer may include organic compounds from reduction of liquid electrolyte solvents (e.g., G4 and TTE).

In certain embodiments, the ionic liquid is a solvate ionic liquid. The ionic liquid may greatly enhance cell safety due to low volatility and/or low flammability. Solvate Ionic Liquids (SILs) may include a coordinating solvent and salt that give rise to a chelate complex with similar properties to ionic liquids.

Certain embodiments provide a semi-solid battery cell anode-free design that reduces manufacturing costs and boosts higher cell level energy density. In certain embodiments, the anode is formed from and on a bare copper foil, thereby reducing costs. Some embodiments increase the volumetric and/or gravimetric energy density of a battery cell by avoiding use of traditional anode materials such as silicon and graphite. For example, in certain embodiments the anode electrode, or battery cell, is free of graphite and free of silicon.

Certain embodiments provide for use of lithium sulfide (Li₂S) as a cathode active material, having a theoretical specific capacity of about 1166 mAh/g.

In certain embodiments, batteries formed as described herein have a cycle life performance of greater than 70% at fifty (50) cycles.

Embodiments of the present disclosure offer advantages over the existing art, though it is understood that other embodiments may offer different advantages, not all advantages are necessarily discussed herein, and no particular advantage is required for all embodiments.

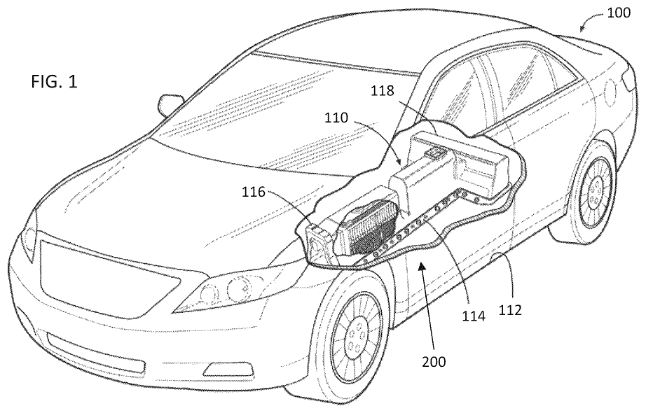

Referring to the drawings, wherein like reference numbers correspond to like or similar components wherever possible throughout the several figures, an electric vehicle 100 having a rechargeable energy storage system (RESS) 110 including a plurality of battery cells 200 in a battery stack, is shown in FIG. 1. The term “battery” used alone herein may refer to a battery module, battery cell or cell stack. The term “battery pack” used alone may refer to a battery and the battery enclosure system the battery is housed within.

The electric vehicle 100 includes a vehicle chassis 112. RESS 110 is provided with a battery tray 114. Each battery cell 200 may attach to or be supported by battery tray 114, which in turn, may attach to the vehicle chassis 112 to secure RESS 110 to electric vehicle 100.

The electric vehicle 100 may also include a battery disconnect unit 116, which is connected to RESS 110 and provides electrical communication between the battery cells 200 and electrical systems (not shown) of electric vehicle 100.

The RESS 110 is further provided with a battery cover 118 that extends over and around the battery cells 200. The battery cover 118 may protect the battery cells 200 from being damaged, as well as provide electrical insulation to the high voltage of the battery cells 200.

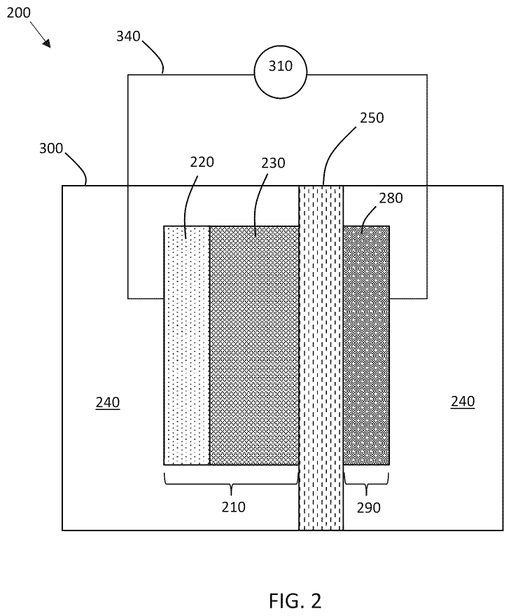

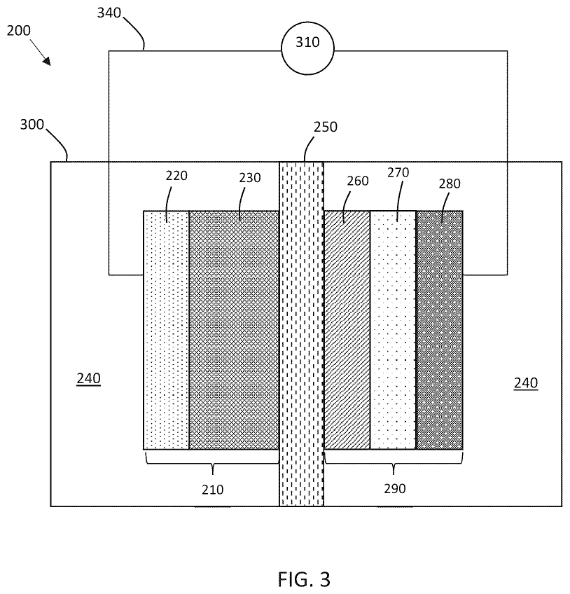

FIGS. 2 and 3 schematically illustrate a lithium-ion battery cell 200 of FIG. 1. Specifically, FIG. 2 illustrates the initial structure of the battery cell 200 and FIG. 3 illustrates the structure of the battery cell 200 after performing a charge cycle or cycles.

As shown in FIG. 2, as initially constructed, battery cell 200 includes a cathode 210. Cathode 210 may include a cathode current collector 220 with a catholyte or cathode active material layer 230 applied thereto.

In certain embodiments herein, the cathode current collector 220 is aluminum.

In certain embodiments herein, the catholyte or cathode active material layer 230 comprises a main or primary cathode active material, an optional additional cathode active material, binder, conductive carbon, and/or a solid-state electrolyte.

In certain embodiments, the main cathode active material is, comprises, or consists of lithium sulfide (Li₂S). The lithium sulfide may be provided in the form of pure lithium sulfide or in the form of a composite, such as in a lithium sulfide/carbon (Li₂S/C) composite, or a lithium sulfide/transition metal composite. Transition metals for use in lithium sulfide/transition metal composites may include iron, copper, and cobalt, or other suitable metals. In certain embodiments, the cathode active material layer 230 is comprised of from fifty (50) to ninety (90) weight percent of the main cathode active material.

In certain embodiments, the cathode active material layer 230 does not include any additional cathode active material. In other embodiments, the additional cathode active material is present in the cathode active material layer 230. The additional cathode active material may be, may include, or may consist of a transition metal sulfide or transition metal sulfides. Suitable transition metal sulfides may include iron disulfide (FeS₂), molybdenum disulfide (MoS₂), tungsten disulfide (WS₂), titanium disulfide (TiS₂), tantalum disulfide (TaS₂), molybdenum tungsten disulfide (MoWS₂), molybdenum rhenium disulfide (MoReS₂), niobium tungsten disulfide (NbWS₂), tungsten tellurium disulfide (WTeS₂), and tin selenium disulfide (SnSeS₂). In certain embodiments, the cathode active material layer 230 is comprised of from fifty (50) to ninety (90) weight percent of total cathode active material, i.e., the summed amount of main cathode active material and additional cathode active material.

In certain embodiments, the binder or binders in the cathode active material layer 230 may be, may comprise, or may consist of styrene-butadiene rubber (SBR), hydrogenated nitrile butadiene rubber (HNBR), polyvinylidene difluoride (PVDF), poly(vinylidene fluoride-co-hexafluoropropylene) (PVDF-HFP), poly(ethylene oxide) (PEO), polytetrafluoroethylene (PTFE), and/or poly(tetrafluoroethylene-co-perfluoro(3-oxa-4-pentenesulfonic acid)) lithium salt.

In certain embodiments, the conductive carbon in the cathode active material layer 230 may be, may comprise, or may consist of carbon black, carbon nanotubes, graphene, and/or acetylene black. Examples of suitable materials include Ketjenblack products commercially available from Nouryon, Super PR carbon black commercially available from Imerys, or LITX™ products commercially available from Cabot Corporation. In certain embodiments, the cathode active material layer 230 is comprised of from one (1) to five (5) weight percent of the conductive carbon.

In certain embodiments, the solid state electrolyte in the cathode active material layer 230 is, comprises, or consists of a sulfidic solid state electrolyte or electrolytes (SSE). Suitable sulfidic solid state electrolytes include yLi₂S·(100−y−x)P₂S₅·xP₂O₅, wherein y is from 70 to 80 mol % and x is from 1 to 10 mol %; Li₁₀MP₂S₁₂, wherein M is Si, Ge, or Sn; and electrolytes of the formula A₁₂₋ₘ₋ₓ⁺(M^{m+}Y₄²⁻)Y₂₋ₓ²⁻Xₓ⁻, wherein A⁺=Li⁺, Cu⁺, Ag⁺; M^{m+}=Si⁴⁺, Ge⁴⁺, Sn⁴⁺, P⁵⁺, As⁵⁺; Y²⁻=O²⁻, S²⁻, Se²⁻, Te²⁻; X⁻=Cl⁻, Br⁻, I⁻; and 0≤x≤2, such as argyrodite (Li₆PS₅Cl). In certain embodiments, the cathode electrode comprises up to thirty (30) weight percent of the solid state electrolyte. SSE may be present in the cathode electrode to increase the cell ionic conductivity, such as by generating more ionic conduction pathway. Increased cell ionic conductivity may be desirable when using Li₂S as the active materials because Li₂S has poor ionic and electrical conductivity.

As shown in FIG. 2, the battery cell 200 further includes a separator 250. In certain embodiments, separator 250 is, comprises or consists of a porous membrane. For example, the porous membrane may be a polypropylene (PP), polyethylene (PE), or polypropylene/polyethylene (PE/PP) porous membrane. In certain embodiments, the separator 250 may include an inorganic coating or fillers to improve wettability. For example, the separator 250 may include alumina or silica powder or fibers. Separator 250 may be provide with improved wettability when the SIL liquid electrolyte is viscous.

In other embodiments, separator 250 is, comprises or consists of a solid state electrolyte (SSE), such as a sulfidic solid state electrolyte or electrolytes. Suitable sulfidic solid state electrolytes include yLi₂S·(100−y−x)P₂S₅·xP₂O₅, wherein y is from 70 to 80 mol % and x is from 1 to 10 mol %; Li₁₀MP₂S₁₂, wherein M is Si, Ge, or Sn; and electrolytes of the formula A₁₂₋ₘ₋ₓ⁺(M^{m+}Y₄²⁻)Y₂₋ₓ²⁻Xₓ⁻, wherein A⁺=Li⁺, Cu⁺, Ag⁺; M^{m+}=Si⁴⁺, Ge⁴⁺, Sn⁴⁺, P⁵⁺, As⁵⁺; Y²⁻=O²⁻, S²⁻, Se²⁻, Te²⁻; X⁻=Cl⁻, Br⁻, I⁻; and 0≤x≤2, such as argyrodite (Li₆PS₅Cl).

FIG. 2 also illustrates that the battery cell 200 further includes an anode 290 in the form of an anode current collector 280. In certain embodiments, the anode current collector 280 is copper foil, carbon-coated copper, copper mesh, polyethylene terephthalate (PET) supported copper foil, or a combination thereof. The current collector 280 may have a thickness of from four (4) um to twenty-five (25) um.

As shown in FIG. 2, cathode 210 and anode 290 are encapsulated in a container 300, which may be a hard case (e.g., a metallic case) or a soft pouch (e.g., a polymer pouch), for example. A cell electrolyte 240 may also be located within container 300. The cell electrolyte 240 may be a liquid electrolyte that includes one or more lithium salts dissolved in a non-aqueous solvent that has been specifically formulated and prepared for service in the lithium-ion battery cell 200.

In certain embodiments, cell electrolyte 240 may be a solvate ionic liquid (SIL) electrolyte. In certain embodiments, the solvate ionic liquid is diluted in a fluorinated ether diluent, i.e., cell electrolyte 240 may include a solvate ionic liquid and a fluorinated ether diluent. In such embodiments, the cell electrolyte 240 may have a weight ratio of solvate ionic liquid (SIL) electrolyte to fluorinated ether diluent, i.e., a SIL/Diluent weight ratio, of from 1:0.5 to 1:5. In certain embodiments, the electrolyte loading, i.e., the total amount for SIL and diluent in the battery cell is from 1 to 10 g/Ah, such as from 1 to 4 g/Ah or from 6 to 10 g/Ah.

In certain embodiments, the SIL electrolyte is, comprises, or consists of Li[G2]TFSI, Li[G2]TFSI, Li[G3]TFSI, Li[G4]TFSI, Li[G3]FSI, Li[G4]FSI, Li[G3]BETI, Li[G4]BETI, Li[G3]CTFSI, Li[G4]CTFSI, Li[G3]ClO₄, Li[G4]ClO₄, Li[G3]BF₄, and/or Li[G4]BF₄.

In certain embodiments, the fluorinated ether diluent is, comprises, or consists of 1,1,2,2 tetrafluoroethyl-2,2,3,3-tetrafluoropropyl ether (TTE), Ethyl 1,1,2,2-tetrafluoroethyl ether (ETE), Hexafluoroisopropyl methyl ether (HFME), 1,1,2,2-Tetrafluoroethyl 2,2,2-Trifluoroethyl Ether, Ethyl 1,1,2,3,3,3-Hexafluoropropyl Ether, Methyl Nonafluorobutyl Ether (mixture of isomers), Difluoromethyl 2,2,3,3-Tetrafluoropropyl Ether, Bis(2,2,2-trifluoroethyl) ether (BTFE), 1H,1H,5H-Octafluoropentyl 1,1,2,2-Tetrafluoroethyl Ether (OTE), 1,1,2,3,3,3 hexafluoropropyl-2,2,2-trifluoroethyl ether, 1,1,1,2,2,3,4,5,5,5-Decafluoro-3-methoxy-4-(trifluoromethyl) pentane, Fluoromethyl 1,1,1,3,3,3-Hexafluoroisopropyl Ether, 1,1,2,3,3,3-Hexafluoropropyl Methyl Ether, Hexafluoroisopropyl Methyl Ether, Methyl 2,2,3,3,3-Pentafluoropropyl Ether, and/or Methyl 1,1,2,2-Tetrafluoroethyl Ether.

As shown in FIG. 2, the cathode 210 and anode 290 are situated on opposite sides of the separator 250. The separator 250 is configured to conduct lithium ions and, in one embodiment, the cell electrolyte 240. The cathode current collector 220 and the anode current collector 280 are connected by an interruptible external circuit 340 that allows an electric current to pass between the cathode 210 and the anode 290 to electrically balance migration of lithium ions.

FIG. 3 illustrates the battery 200 of FIG. 2 after charge cycling or activation, such as at 3.8 Volts. As shown, charge cycling causes the formation of an anode active material layer 270 on the anode current collector 280 and an electrochemically stable solid electrolyte interphase (SEI) layer 260 on the anode active material layer 270.

Specifically, a layer 270 of lithium is plated onto the anode current collector 280 as lithium ions from the cathode travel through the electrolyte 240 and are plated onto the anode current collector 280. For example, lithium ions extracted from the separator 250 are electroplated onto the surface of the anode current collector 280, forming a deposited lithium layer together with the electrochemically stable solid electrolyte interphase (SEI) layer 260 during the charging process. The deposited lithium is the only available lithium sources for discharge. From this reason, the safety hazard often posed in the lithium metal battery is greatly reduced because there is no active lithium source at the anode side.

During discharge (e.g., electro-dissolution), lithium ions are stripped from anode active material layer 270, travel through electrolyte 240, and react with and incorporate into cathode active material 230.

As shown, the solid electrolyte interphase (SEI) layer 260 is formed over the plated lithium layer 270. The SEI layer 260 is an electrically insulating and ionically conductive passivation layer that serves as a protection layer for the freshly plated lithium layer 270 and may extend the cycle life of the lithium ion battery. In embodiments herein, the combination of slightly dissolved lithium sulfide (Li₂Sₓ) in the SIL/diluent electrolyte 240 provides for forming the ion-conducting SEI layer 260. Specifically, reduced polysulfides are formed as the SEI layer 260 on the lithium metal anode active material layer 270. The reduced polysulfides may include lithium sulfide (Li₂S) and/or lithium disulfide Li₂S₂.

In certain embodiments, the SEI layer 260 is, comprises, consists essentially of, or consists of lithium sulfide (Li₂S) and/or lithium disulfide Li₂S₂. The SEI layer 260 may further comprise lithium fluoride (LiF) and/or lithium carbonate (Li₂CO₃). It may also comprise of a variety of organic compounds formed by reducing liquid electrolyte solvents (e.g. G4 and TTE) and/or salt. For example, the lithium metal SEI layer 260 may include inorganic compounds from the reduction of liquid electrolyte salt (LiTFSI) and solvents (e.g., G4 and TTE). Further, the lithium metal SEI layer 260 may include organic compounds from reduction of liquid electrolyte solvents (e.g., G4 and TTE).

After activation, at least a portion of the lithium sulfide of the cathode active material layer 230 may be present as slightly dissolved lithium polysulfides (Li₂Sₓ), where x is from 2 to 8. In certain embodiments, the lithium polysulfides include compounds of Li₂Sₓ, where x is 1, 2, 4, and 6.

In certain embodiments, the cathode active material 230 can store lithium ions at a higher electric potential than the anode electroactive material layer 270.

An exemplary battery is comprised of sixty (60) weight percent of a lithium sulfide carbon composite (Li₂S/C) as a main cathode active material; twenty (20) weight percent of an additional cathode active material; ten (10) weight percent of carbon black as the conductive carbon; ten (10) weight percent of hydrogenated nitrile butadiene rubber (HNBR) as the binder; a separator or SSE; and a bare copper foil as the anode current collector. The exemplary battery includes an electrolyte formed from Li[G4]TFSI, as the solvate ionic liquid, and 1,1,2,2-tetrafluoroethyl-2,2,3,3-tetrafluoropropyl ether (TTE), as the fluorinated ether diluent, in a 1:4 v/v dilution. The exemplary battery has a loading of 2 mg/cm². Further, the exemplary battery cell maintains a capacity of more than 70% after 50 cycles.

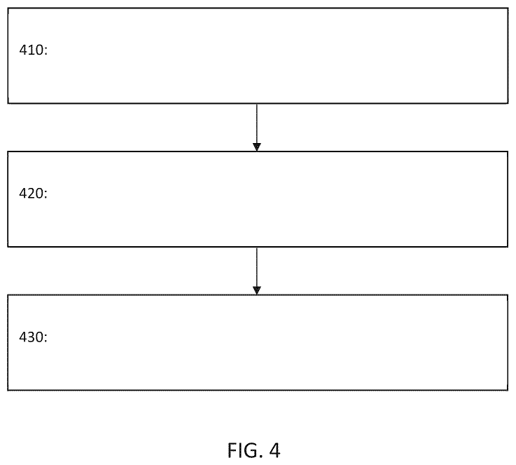

Referring now to FIG. 4, a method 400 for forming a battery cell is described.

Method 400 includes, at operation 410, interconnecting a cathode current collector 220 and an anode current collector 280 to form a circuit 340. As described above, the anode current collector 280 may be a bare foil, such as a bare copper foil. Further, the cathode current collector 220 may be aluminum and may be in contact with a cathode active material provided in a layer 230. As described above, the cathode active material may include lithium sulfide (Li₂S) as a main cathode active material. Further, the cathode active material may include an additional cathode active material as described above. In addition to cathode active material(s), the layer 230 may include binder, conductive carbon, and a solid state electrolyte, such as a sulfidic solid state electrolyte selected from yLi₂S·(100−y−x)P₂S₅·xP₂O₅, wherein y is from 70 to 80 mol % and x is from 1 to 10 mol %; Li₁₀MP₂S₁₂, wherein M is Si, Ge, or Sn; and electrolytes of the formula A₁₂₋ₘ₋ₓ⁺(M^{m+}Y₄²⁻)Y₂₋ₓ²⁻Xₓ⁻, wherein A⁺=Li⁺, Cu⁺, Ag⁺; M^{m+}=Si⁴⁺, Ge⁴⁺, Sn⁴⁺, P⁵⁺, As⁵⁺; Y²⁻=O²⁻, S²⁻, Se²⁻, Te²⁻; X⁻=Cl⁻, Br⁻, I⁻; and 0≤x≤2, such as argyrodite (Li₆PS₅Cl).

Method 400 may include, at operation 420, separating the cathode current collector 220 and cathode active material 230 from the anode current collector 280 with a separator in the form of a membrane and/or in the form of an electrolyte including a solvate ionic liquid (SIL) and a fluorinated ether diluent.

Method 400 may continue at operation 430 with performing an activation process. The activation process may include extracting lithium ions from the cathode active material with the SIL electrolyte diluted in the fluorinated ether diluent; electroplating lithium ions from the cathode active material onto the anode current collector to form a layer of anode active material; and forming a solid electrolyte interphase (SEI) layer over the layer of anode active material, wherein the SEI layer is formed from polysulfide.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A battery cell comprising:
a cathode electrode comprising a cathode active material, wherein the cathode active material comprises lithium sulfide (Li₂S);
an anode current collector serving as an anode electrode;
a solvate ionic liquid (SIL) electrolyte; and
a fluorinated ether diluent.

2. The battery cell of claim 1, further comprising a solid-electrolyte interphase (SEI) layer comprised of Li₂S and Li₂S₂.

3. The battery cell of claim 1, further comprising:
a lithium plating layer formed over the anode current collector; and
a solid-electrolyte interphase (SEI) layer formed over the lithium plating layer, wherein the SEI layer is comprised of reduced polysulfides comprising Li₂S and Li₂S₂.

4. The battery cell of claim 1, wherein the cathode active material comprises a composite of lithium sulfide (Li₂S) and carbon.

5. The battery cell of claim 1, wherein the cathode active material further comprises a transition metal sulfide.

6. The battery cell of claim 5, wherein the cathode electrode comprises from about fifty (50) to about ninety (90) weight percent of the cathode active material, based on a total weight of the cathode electrode.

7. The battery cell of claim 1, wherein the cathode electrode further comprises a solid state electrolyte (SSE), wherein the solid state electrolyte is a sulfidic solid state electrolyte selected from:
yLi₂S·(100−y−x)P₂S₅·xP₂O₅, wherein y is from 70 to 80 mol % and x is from 1 to 10 mol %;
Li₁₀MP₂S₁₂, wherein M is Si, Ge, or Sn; and
electrolytes of the formula A₁₂₋ₘ₋ₓ⁺(M^{m+}Y₄²⁻)Y₂₋ₓ²⁻Xₓ⁻ wherein A⁺=Li⁺, Cu⁺, Ag⁺; M^{m+}=Si⁴⁺, Ge⁴⁺, Sn⁴⁺, P⁵⁺, As⁵⁺; Y²⁻=O²⁻, S²⁻, Se²⁻, Te²⁻; X⁻=Cl⁻, Br⁻, I⁻; and 0≤x≤2; and
wherein the cathode electrode comprises up to thirty (30) weight percent of the solid state electrolyte.

8. The battery cell of claim 7, wherein the cathode electrode further comprises a binder, wherein the binder is selected from styrene-butadiene rubber (SBR), hydrogenated nitrile butadiene rubber (HNBR), polyvinylidene difluoride (PVDF), poly(vinylidene fluoride-co-hexafluoropropylene) (PVDF-HFP), poly(ethylene oxide) (PEO), polytetrafluoroethylene (PTFE), and poly(tetrafluoroethylene-co-perfluoro(3-oxa-4-pentenesulfonic acid)) lithium salt, and wherein the cathode electrode comprises five (5) to ten (10) weight percent of the binder, based on a total weight of the cathode electrode.

9. The battery cell of claim 7 wherein the cathode electrode further comprises conductive carbon, wherein the conductive carbon is selected from carbon black, carbon nanotubes, graphene, and/or acetylene black, and wherein the cathode electrode comprises up to five (5) weight percent of the conductive carbon, based on a total weight of the cathode electrode.

10. The battery cell of claim 1, further comprising a separator, wherein the separator comprises a polypropylene (PP), polyethylene (PE), or polypropylene/polyethylene (PE/PP) porous membrane.

11. The battery cell of claim 1, wherein the SIL electrolyte is selected from Li[G2]TFSI, Li[G2]TFSI, Li[G3]TFSI, Li[G4]TFSI, Li[G3]FSI, Li[G4]FSI, Li[G3]BETI, Li[G4]BETI, Li[G3]CTFSI, Li[G4]CTFSI, Li[G3]ClO₄, Li[G4]ClO₄, Li[G3]BF₄, and Li[G4]BF₄.

12. The battery cell of claim 1, wherein the fluorinated ether diluent is selected from 1,1,2,2 tetrafluoroethyl-2,2,3,3-tetrafluoropropyl ether (TTE), Ethyl 1,1,2,2-tetrafluoroethyl ether (ETE), Hexafluoroisopropyl methyl ether (HFME), 1,1,2,2-Tetrafluoroethyl 2,2,2-Trifluoroethyl Ether, Ethyl 1,1,2,3,3,3-Hexafluoropropyl Ether, Methyl Nonafluorobutyl Ether (mixture of isomers), Difluoromethyl 2,2,3,3-Tetrafluoropropyl Ether, Bis(2,2,2-trifluoroethyl) ether (BTFE), 1H,1H,5H-Octafluoropentyl 1,1,2,2-Tetrafluoroethyl Ether (OTE), 1,1,2,3,3,3 hexafluoropropyl-2,2,2-trifluoroethyl ether, 1,1,1,2,2,3,4,5,5,5-Decafluoro-3-methoxy-4-(trifluoromethyl) pentane, Fluoromethyl 1,1,1,3,3,3-Hexafluoroisopropyl Ether, 1,1,2,3,3,3-Hexafluoropropyl Methyl Ether, Hexafluoroisopropyl Methyl Ether, Methyl 2,2,3,3,3-Pentafluoropropyl Ether, and Methyl 1,1,2,2-Tetrafluoroethyl Ether.

13. The battery cell of claim 1, wherein the SIL electrolyte and the fluorinated ether diluent are present in a SIL/diluent weight ratio of from 1:0.5 to 1:5 weight ratio.

14. The battery cell of claim 1, wherein the electrolyte loading is from 1 to about 10 g/Ah.

15. The battery cell of claim 1, wherein the anode current collector is copper foil, carbon-coated copper, copper mesh, polyethylene terephthalate (PET) supported copper foil, or a combination thereof.

16. A vehicle comprising:
a rechargeable energy storage system (RESS) including battery cells, wherein each battery cell comprises:
a cathode electrode;
an anode current collector acting as an anode electrode;
a separator;
a lithium plating layer formed over the anode current collector; and
a solid-electrolyte interphase (SEI) layer formed over the lithium plating layer, wherein the SEI layer is comprised of reduced polysulfides comprising Li₂S and Li₂S₂.

17. The vehicle of claim 16, wherein each battery cell further comprises and/or wherein the separator comprises:
a solvate ionic liquid (SIL) electrolyte; and
a fluorinated ether diluent.

18. The vehicle of claim 17, wherein in each battery cell:
the cathode electrode comprises a cathode active material, a solid electrolyte, and a binder;
the cathode active material comprises lithium sulfide (Li₂S) and a transition metal sulfide; and
the cathode electrode comprises from about fifty (50) to about ninety (90) weight percent of the cathode active material, based on a total weight of the cathode electrode.

19. A method for forming a battery cell, the method comprising:
interconnecting a cathode current collector and an anode current collector to form a circuit, wherein the cathode current collector contacts a cathode active material comprising lithium sulfide (Li₂S); and
performing an activation process including:
electroplating lithium ions from the cathode active material onto the anode current collector to form a layer of anode active material; and
forming a solid electrolyte interphase (SEI) layer over the layer of anode active material, wherein the SEI layer is formed from polysulfide.

20. The method of claim 19, wherein the cathode active material comprising lithium sulfide (Li₂S) and the anode current collector are in contact with a solvate ionic liquid (SIL) electrolyte diluted in a fluorinated ether diluent, and wherein the method further comprises extracting lithium ions from the cathode active material with the SIL electrolyte diluted in the fluorinated ether diluent.
